(19) United States
(12) Patent Application Publication
(10) Pub. No.: US 2015/0338925 A1
(43) Pub. Date: Nov. 26, 2015

(54) CAUSING GESTURE RESPONSES ON CONNECTED DEVICES

(71) Applicant: Orbotix, Inc., Boulder, CO (US)

(72) Inventors: Ian H. Bernstein, Boulder, CO (US); Adam Wilson, Longmont, CO (US); Paul Berberian, Boulder, CO (US); John Blakely, Niwot, CO (US); Isaac Davenport, Boulder, CO (US)

(21) Appl. No.: 14/720,586

(22) Filed: May 22, 2015

Related U.S. Application Data
(60) Provisional application No. 62/002,706, filed on May 23, 2014.

(51) Int. Cl. G06F 3/01; G09G 5/00; G06T 1/60

(52) U.S. Cl. CPC G06F 3/017; G06T 1/60; G09G 5/003; G09G 2370/02

(57) ABSTRACT

A system and method to cause associated connected devices to perform gestures in response to user interactions with a connected device paired with the associated connected devices. The method includes receiving a gesture signal indicating a user interaction with a first connected device, identifying one or more connected devices associated with the first connected device, and, based on the user interaction, generating and transmitting a response signal to cause the one or more associated connected devices to perform a specified gesture signifying the user interaction with the first connected device.

### RELATED APPLICATION

This application claims the benefit of priority to U.S. Provisional Patent Application Ser. No. 62/002,706, entitled “CAUSING GESTURE RESPONSES ON CONNECTED DEVICES,” filed on May 23, 2014; the aforementioned priority application being incorporated by reference in its entirety.

### BACKGROUND

Connected device applications are becoming more interactive. Advances in wireless technology allow for greater scope in connectivity and user interaction of such connected devices.

### BRIEF DESCRIPTION OF THE DRAWINGS

The disclosure herein is illustrated by way of example, and not by way of limitation, in the figures of the accompanying drawings and in which like reference numerals refer to similar elements, and in which:

FIG. 1 is an example block diagram depicting a system for causing gesture responses for connected devices;

FIG. 2 is an example flow chart showing a method for causing gesture responses for connected devices;

FIG. 3 is an example flow chart illustrating a method for associating devices and selecting response gestures for associated devices;

FIG. 4 is an example of a connected device to receive user interactions and perform response gestures; and

FIG. 5 is an example block diagram depicting a computer system upon which examples described may be implemented.

### DETAILED DESCRIPTION

A system and method are provided relating to causing gesture responses on connected devices. The method can be performed on, for example, a server computing system implemented in accordance with an application running on any number of computing devices (e.g., mobile computing devices). Accordingly, the system can maintain a database storing information, such as user profile data, unique identifiers for connected devices to associate those devices with their respective owners, and data corresponding to device interaction and response.

The method implemented by the system can include receiving a gesture signal indicating a user interaction with the user's connected device. The connected device can be a robotic figurine, or other mechanical toy, including sensors, mechanical systems, a controller, audio output, a lighting system, a transceiver, etc. Accordingly, the connected device can perform a variety a gestures or actions which include physical, audible, visual, and/or haptic gestures. Furthermore, the connected device can receive and transmit signals indicating user interactions (e.g., physical interactions) with the connected device, and causing the connected device to perform response gestures according to a response signal.

Upon receiving a gesture signal from a user's connected device, the disclosed system can perform a lookup, in the database, to identify related connected devices associated with the user's connected device. Once associated connected devices are identified, the system can generate and transmit a response signal to the associated connected devices. The response signal can cause the associated connected devices to perform one or more gestures signifying the user interaction with the user's connected device.

As an example, a user can perform a squeeze action on the user's connected device, which can be interpreted as a hug input on the connected device. The connected device can relay a gesture signal through the user's mobile computing device to the disclosed system over a network (e.g., the Internet). The gesture signal can indicate that the connected device received a hug input. Accordingly, the system can look up associated devices in the database. Such associated devices may correspond to devices associated with the user's children, relatives, friends, and the like. The system can identify those associated devices and generate a response signal to signify that the user's connected device received the hug input. The response signal can be transmitted to the associated devices, which, in response, can perform gesture actions (e.g., initiate a physical action, trigger visual indicators such as lights, perform audible or haptic actions, etc.).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules or components of a system. A programmatic module or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein can be implemented, in whole or in part, on computing devices such as digital cameras, digital camcorders, desktop computers, cellular or smart phones, personal digital assistants (PDAs), laptop computers, printers, digital picture frames, and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples can be carried and/or executed. In particular, the numerous machines shown with examples include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smart phones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a non-transitory computer usable carrier medium capable of carrying such a program.

System Description

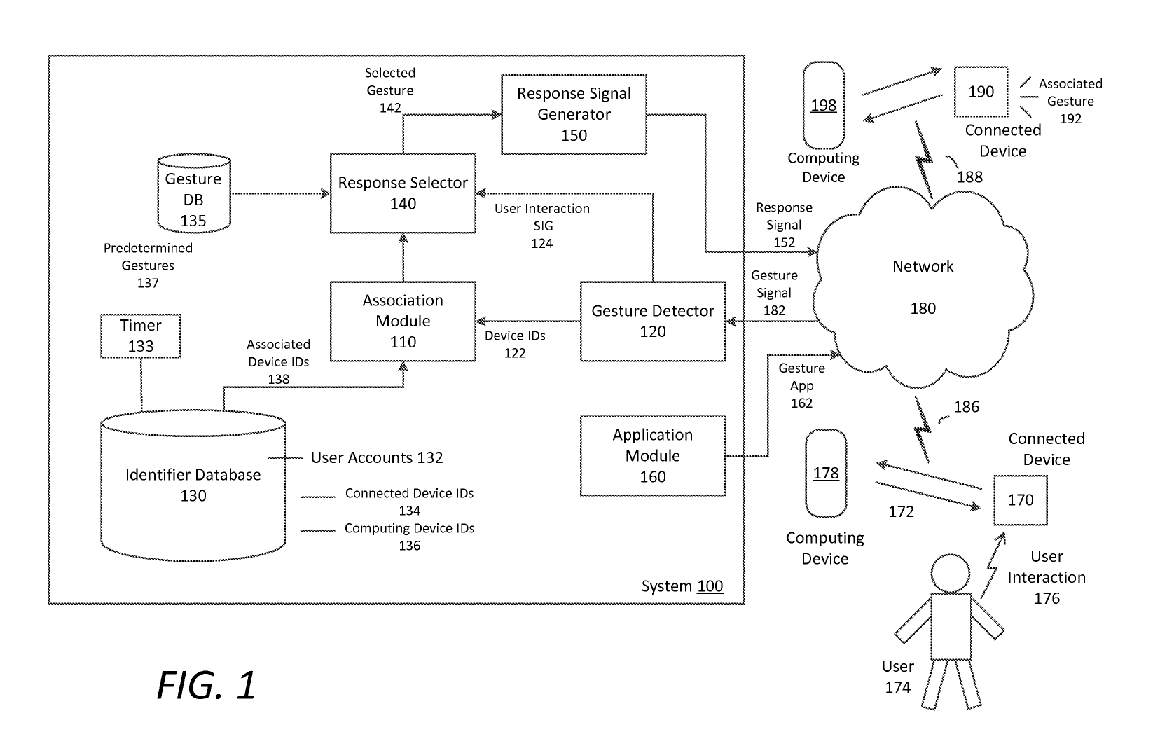

FIG. 1 is an example block diagram depicting a system for causing gesture responses for connected devices. The system 100 can include an application module 160 to provide a gesture application 162 to any number of computing devices. The gesture application 162 can be provided to the computing device via a storage medium, such as a portable storage device. Additionally or alternatively, the gesture application 162 can be downloaded via an application store over a network 180. The gesture application 162 can further be associated with a mechanical device, such as a robotic figurine or other robotic device.

Once configured on a computing device 178, 198, the gesture application 162 can be launched and connected to the system 100 over the network 180. Communication links 186, 188 can be established between the computing devices 178, 198 and the network to communicate signals to the system 100. For example, the communication links 186, 188 can enable a Wi-Fi system on each of the computing devices 178, 198 to connect to the Internet. Additionally or alternatively, the computing devices 178, 198 can communicate with the system 100 over such communication protocols as standardized by the Institute of Electrical and Electronics Engineers (IEEE), such as any of the IEEE 802.11 protocols.

Furthermore, upon launch of the gesture application 162 a respective computing device (e.g., computing device 178) can establish a wireless link 172 with a connected device 170. For example, launch of the gesture application 162 can automatically establish a Bluetooth link between the computing device 178 and the connected device 170. Accordingly, various feedback mechanisms can be enabled between the computing device 178 and the connected device 170. For example, the gesture application 162 can provide a user interface on a display of the computing device 178 to allow the user 174 to provide inputs to mechanically, visually, and/or audibly control the connected device 170. Additionally or alternatively, the user 174 can perform user interactions 176 with the connected device 170, which, in response, can perform any number of predetermined responses based on the user interaction 176.

A number of sensors on the connected device 170 can provide an input regarding the type of user interaction 176. For example, the user interaction 176 may exemplify a hug upon the connected device 170 which may be sensed and communicated to the computing device 178. Other user interactions 176 with the connected device 170 can include, for example, squeezing, throwing, tapping, rotating, dropping, shaking, twisting, or breaking a whole or a portion of the connected device 170. Such user interactions 176 can be sensed by the connected device 170 and data indicative of such user interactions 176 can be communicated to the system 100 either directly from the connected device 170, or relayed through the computing device 178. Accordingly, a gesture signal 182 is communicated to the system 100 corresponding to the device(s) 178, 170, and the specific user interaction 176 performed by the user 174 on the connected device 170.

Additionally or alternatively, the user 174 can produce a gesture signal 182 via user input on the computing device 178. Accordingly, the gesture application 162 can provide a graphic user interface allowing the user 174 to select any number of gestures to be performed by an associated connected device 190. For example, the graphic user interface can provide a selectable list of predetermined gestures 137 from a gesture database 135, that the user 174 can select from in order to cause a specified gesture to be performed by the associated connected device 190

As an addition or alternative, the connected devices 170, 190 can be directly connected to the system 100 over the network 180. In such arrangements, no relay through respective computing devices 178, 198 is necessary. Furthermore, in such arrangements, such connected devices 170, 190 may be in communication with the system over a Wi-Fi network according to IEEE protocols (e.g., any IEEE 802.11 protocol). The connected device 170 can be preprogrammed to communicate data indicating user interactions 176 on the connected device 170. Furthermore, the connected device 190 can be preprogrammed to perform the same, and/or to receive response signals 152 that trigger an associated gesture 192.

The gesture signal 182 can be detected by a gesture detector 120 included in the system 100. The gesture detector 120 can monitor connected devices over the network 180 for such gesture signals 182, or can passively receive such gesture signals 182. The gesture signal 182 can include information relating to the connected device 170, the computing device 178, and/or the user 174. For example, the gesture signal 182 can include unique identifiers corresponding to the computing device 178 and/or the connected device 170. The gesture signal 182 can further indicate the type of user interaction 176 performed on the connected device 170 by the user 174. For example, the gesture signal 182 can indicate that the user interaction 176 corresponds to a squeeze input on the connected device 170.

Accordingly, the gesture detector 120 can parse the gesture signal 182 to determine the device identifiers 122 for the computing device 178 and/or the connected device 170. The gesture detector 120 can output a signal indicating the device identifiers 122 to an association module 110. Furthermore, the gesture detector 120 can parse the gesture signal 182 to determine the user interaction 176 on the connected device 170. The gesture detector 120 can output an interaction signal 124 indicating the user interaction 176 on the connected device 170 included in the gesture signal 182 to a response selector 140.

The association module 110 can receive the device identifiers 122 from the gesture detector 120 and perform a look up in an identifier database 130 included in the system 100. The identifier database 130 can include user accounts 132 and/or user profiles associated with computing devices (e.g., computing devices 178, 198) and/or connected devices (e.g., connected devices 170, 190) as disclosed. For example, upon installation, purchase, launch, etc., of the gesture application 162 on the computing device 178, the system 100 can set up a user account 132, which can include one or more connected device identifiers 134 and one or more computing device identifiers associated with the user 174. For example, the user account 132 may include a connected device identifier corresponding to the connected device 170, and a computing device identifier corresponding to the computing device 178. Alternatively, the user account 132 may be set up to include any number of identifiers for connected devices and/or computing devices associated with the user 174 or any other connected device or computing device.

Furthermore, the identifier database 130 can include association information indicating devices associated with the computing device 178, the connected device 170, and/or the user 174. Such association information can include associated device identifiers 138 for devices associated as described. For example, any combination of connected devices and computing devices can be paired (e.g., via established connection or inductive pairing), which can be detected by the system 100 to form associations between paired devices. Alternatively, the connected device 170 and the associated connected device 190 can be preconfigured as a pair, and therefore the identifier database 130 can include association information indicating that the connected device 170 and the associated connected device 190 are indeed associated.

In response to receiving the device identifiers 122 from the gesture detector 120, the association module 110 can look up, in the identifier database 130 the associated device identifiers 138 corresponding to any number of connected devices associated with the computing device 178, the connected device 170, and/or the user 174. The associated device identifiers 138 can be sent to the response selector 140, which determines which response gesture is to be performed by associated devices corresponding to the associated device identifiers 138.

The response selector 140 can also receive the user interaction signal 124 from the gesture detector 120, which indicates the user interaction 176 performed on the connected device 170. The response selector 140 can process the user interaction signal 124 to determine the type of user interaction 176 performed on the connected device. Accordingly, the response selector 140 can make a determination regarding an associated gesture 192 to be performed by the associated connected device 190. For example, based on the user interaction signal 124, the response selector 140 can determine any number of response gestures, each of which can include one or more haptic, visual, audible, or physical gestures to be performed by the connected device 190. Furthermore, the response selector 140 can look up predetermined gestures 137 in a gesture database 135 to select an appropriate response gesture to be performed based on the user interaction 176 with the connected device 170.

As an example, the user interaction 176 may correspond to a squeeze input on the connected device 170, which may cause the connected device 170 itself to perform a gesture including any number or combination of visual, audible, haptic, or physical responses. Based on the user interaction 176 the response selector 140 can look up, in the gesture database 135, a predetermined gesture 137 to response to the user interaction 176. Specifically, the user interaction 176 with the connected device 170 can cause the response selector 140 to choose a predetermined gesture 137 to be performed by the associated connected device 190. For example, the response selector 140 can select a predetermined gesture 142 form the stored predetermined gestures 137 in the gesture database 135 having a visual response which causes the associated connected device to light up. Furthermore, the selected predetermined gesture 142 can also cause the associated connected device 190 to provide a haptic response in a predetermined pattern or order. Additionally or alternatively, the selected predetermined gesture 142 can cause mechanical motion of the associated connected device 190, and/or can further cause an audible action, such as speaking predetermined words or phrases.

In variations, the response selector 140 can configure a customized response to the user interaction 176. According to such variations, the response selector 140 can configure any number or combination of visual, audible, haptic, or physical/mechanical gestures to be performed by the associated connected device 190.

Once the response gesture 142 is selected or determined by the response selector 140, the response selector communicates the gesture 142 to a response signal generator 150. The response signal generator 150 generates a response signal 152 incorporating the specific actions to be performed by the associated connected device 190. Accordingly, once the response signal 152 is generated, the response signal generator 150 can transmit the response signal 152 to the associated connected device 190, and other connected devices identified by the associated device identifiers 138. For example, the response signal 152 can be transmitted over the network 180 to the associated connected device 190 directly, or relayed through the computing device 198 to be ultimately received by the associated connected device 190 to perform the associated gesture corresponding to the selected gesture 142 selected by the response selector 140.

In variations, the response signal 152 may be sent over the network 180 to the associated computing device 198 or associated connected device 190 anywhere in the world. The computing device 198 can be connected to the network via a communication link 188 to receive the response signal 152 and relay it to the associated connected device 190 to perform the associated gesture 192.

In further variations, the gesture detector 120 can receive simultaneous gesture signals from any number of associated devices. For example, while receiving the gesture signal 182 corresponding to the user interaction 176 with the connected device 170. The gesture detector 120 may receive a simultaneous signal indicating simultaneous user interaction (by another user) with the associated connected device 190. The association module 110 can recognize such simultaneous interaction, and the response selector 140 may select a predetermined response based on the simultaneous interaction. For example, based on the simultaneous interaction, the response selector 140 may cause the response signal generator 150 to generate simultaneous response signals to be transmitted to both the connected device 170 and the associated connected device 190. The simultaneous response signals can be generated to cause the connected device 170 and the associated connected device 190 to perform the same or similar gestures selected by the response selector 140. Alternatively, the simultaneous response signals may be generated to intensify the gesture performed by the connected device 170 and the associated connected device 190 in response to the simultaneous user interactions.

In still further variations, the system 100 can receive indications or determine that one or more associations have expired or that connected devices have been unpaired. For example, the system 100 can include a timer 133 that can initiate when a connected device 170 and an associated connected device 190 are paired. Upon a predetermined duration, the pairing can expire and the connected device 170 and the associated connected device can be automatically unpaired. This unpairing may involve disassociating the unique identifiers corresponding to the connected device 170 and the associated connected device 190 in the identifier database 130. Such a disassociation can be made by editing a user profile or user account 132 in the identifier database 130.

Additionally or alternatively, the system 100 can receive an unpairing signal indicating that the connected device 170 and the associated connected device 190 have been unpaired. The connected device 170 and the associated connected device 190 can be unpaired, for example, by configuration through an established connection, or otherwise an inductive unpairing. In response to such an unpairing signal being received by the system 100, the identifier database can be accessed to disassociate the unique identifiers corresponding to the connected device 170 and the associated connected device 190.

Further, a specified user interaction 176 on the connected device 170 may ultimately indicate that only one specific associated device, out of a plurality, is to receive a response signal 152. For example, the user 174 may wish to communicate a gesture to a specified robotic teddy bear possessed by the user's son or daughter. A specified user interaction, such as a tapping gesture on the connected device 170, or a squeezing input on a specified portion of the connected device, can be determined by the response selector 140, and the response signal generator 150 can be informed to only transmit a corresponding response signal 152 to the specified robotic teddy bear. Accordingly, the response signal 152 can be generated to cause the robotic teddy bear perform a specified associated gesture 192 based on the specified user interaction.

Further still, the system 100 can detect when two connected devices are within a predetermined distance from each other. Such detection can be performed via location-based resources on the computing devices 178, 198. In response to such detection, the response signal generator 150 can transmit respective response signals to the computing devices 178, 198 to cause them to each perform a predetermined gesture. Such a gesture may be specific to proximity detection by the system 100. Furthermore, such a gesture may be selected to intensify, via a series of response signals 152, as the connected devices 170, 190 get closer in proximity.

Still further, the system 100 can detect instances when computing devices have launched the gesture application 162. Accordingly, prior to receiving the gesture signal 182, the system 100 can receive a launch signal indicating that the computing device 178 has launched the gesture application. Furthermore, prior to transmitting the response signal 152, the system 100 can make a determination whether the associated computing device 198 is currently running the gesture application 162. In response to determining that the associated computing device 198 is not currently running the gesture application 162, the system 100 can associate or tag the user account in the identifier database 130 indicating that a specified response signal 152 selected by the response selector 140 needs to be transmitted to the associated computing device 190. Thus, the system 100 can queue the transmission of the response signal 152 until a subsequent launch signal is received indicating that the associated computing device 198 has launched the gesture application 162. In response to the subsequent launch signal, the response signal 152 can be automatically transmitted to the associated computing device 198 to perform the associated gesture 192.

The computing devices 178, 198 can be any device capable of running the gesture application 162, and/or Wi-Fi enabled devices. Accordingly, such computing devices 178, 198 may correspond to laptops, PCs, smartphones, tablet computing devices, and the like.

Methodology

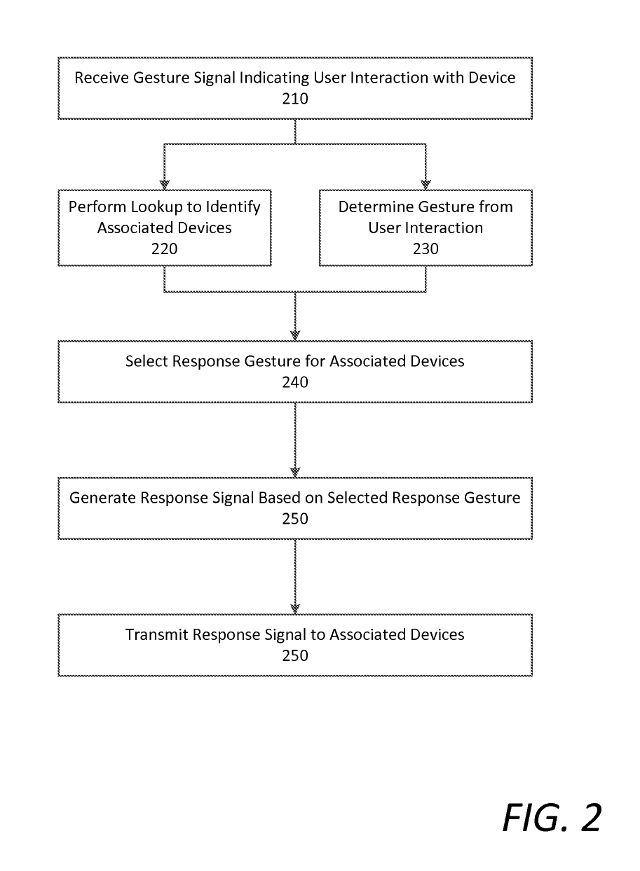

FIG. 2 is an example flow chart showing a method for causing gesture responses for connected devices. In the below discussion of FIG. 2, reference may be made to like reference characters representing various features of FIG. 1 for illustrative purposes. Referring to FIG. 2, the response detector 120 included in the system 100 receives a gesture signal 182 indicating a user interaction 176 with a first connected device 170 (210). In response to receiving the gesture signal 182, an association module 110 performs a lookup in an identifier database 130 to identify connected devices or computing device associated with the first connected device 170 (220).

Furthermore, based on the received gesture signal 182 the gesture detector 120 can determine the user interaction performed on the connected device 170 (230). For example, sensors on the connected device 170 can be triggered during the user interaction 176, the data of which can be communicated to the gesture detector 182. Accordingly, upon determination of the gesture (i.e., squeeze input, shake input, input on a specified portion of the connected device 170), the response selector 140 can determine or otherwise select an appropriate gesture 142 from a collection of predetermined gestures 137 (240). Alternatively, the response selector 140 can cause the response signal generator 150 to generate a custom response in accordance with the user interaction 176.

The response signal generator 150 can then generate a specified response signal 152 according to the selected gesture 142 by the response selector 140 (250). The response signal 152 can be generated by the response signal generator 150 to cause the associated connected device 190 to perform the associated gesture 192. Accordingly, the response signal 152 can then be transmitted to the associated connected device 190 (250).

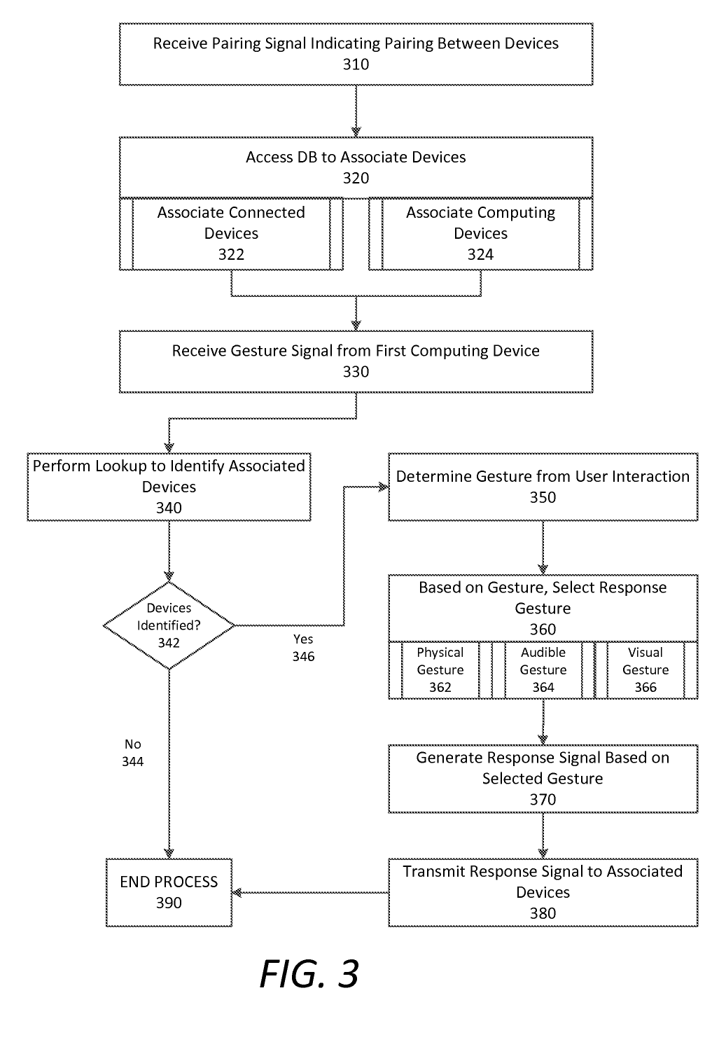

FIG. 3 is an example flow chart illustrating a more detailed method for associating devices and selecting response gestures for associated devices. In the below discussion of FIG. 3, reference may also be made to like reference characters representing various features of FIG. 1 for illustrative purposes. Referring to FIG. 3, the system 100 may receive one or more pairing signals indicating one or more pairings between connected devices (310). For example, connected devices may be paired (and unpaired) via inductive coupling. In response to receiving the one or more pairing signals, the system accesses the identifier database 130 to append or modify user accounts to make associations between the paired devices (320). Accordingly, connected devices (e.g., robotic toys) can be associated in the identifier database 130 (322), and/or computing devices corresponding to the users of the connected devices can be associated in the identifier database (324).

Once all associations are made, the gesture detector 120 can receive any number of gesture signals 182 indicating launched gesture applications 162 and user interactions with connected devices (330). Accordingly, the gesture signals 182 can be received continuously and dynamically and subsequent response signals 152 may be generated continuously and dynamically in response to such gesture signals 182. In response to receiving the gesture signals 182, the association module 110 performs lookups in the identifier database 130 to identify all associated devices (340). The association module 110 determines whether associated devices exist in the identifier database (342). If associated devices are not found in the identifier database 130 (344), the system 100 ends the process (390). However, if associated devices are found for a respective connected device (346), the gesture detector 120 proceeds to determine the gesture performed on the respective connected device based on the user interaction and submit the user interaction signal 124 to the response selector 140 (350).

Based on the gesture inputted on the respective connected device, the response selector 140 can select an appropriate response gesture (360). For example, a squeeze input on the respective connected device can cause the response selector to choose a response gesture that incorporates any number of audio, visual, haptic, and/or physical/mechanical actions. Thus, the response selector 140 can select a predetermined gesture from a gesture database 135, where response gestures are pre-associated with input gestures corresponding to the user interaction with the respective connected device. Additionally or alternatively, the response selector 140 can select any number or combination of physical gestures (362), audible gestures (364), visual gestures (366), or even haptic responses to be performed by the associated devices.

Thereafter, the response signal generator 150 can generate the corresponding response signal 152 corresponding to the selected or determined response gesture from the response selector 140 (370). The response signal 152 is then transmitted to the associated devices to cause them to perform an associated gesture 192 corresponding to the determined or selected gesture by the response selector 140 (380). As provided above, the generated response signal 152 can be transmitted anywhere in the world to the associated connected devices. Furthermore, the response signal is configured to cause the associated device to perform the selected actions corresponding to the determined or selected gesture. Thereafter, the process is ended (390).

Connected Device

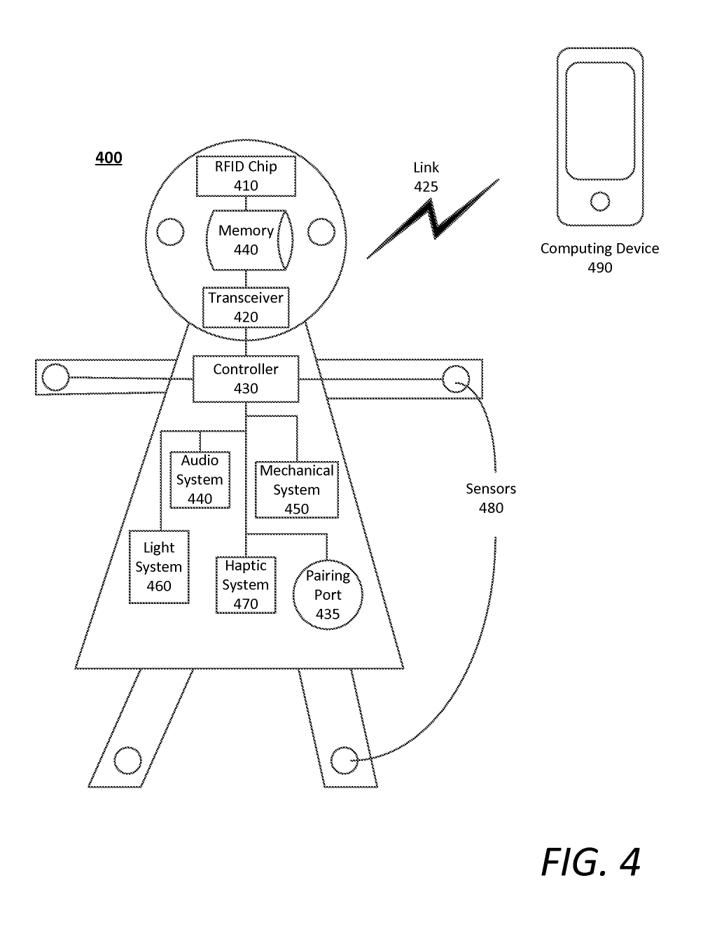

FIG. 4 is an example of a connected device to receive user interactions and perform response gestures. The connected device 400 can be linked to a computing device 490, which, in accordance with the above description, can run a gesture application specific to receiving user interactions and performing gesture responses. The connected device 400 can be linked 425 to the mobile computing device 490 via a communication link, (e.g., Bluetooth, RF, infrared, optical, etc.). The connected device 400 includes electronics within, which allows it to create verbal and non-verbal gestures, utilizing vibrations, tones, lights, and/or mechanical gestures.

The connected device 400 can be directly connected to a network for communication with other connected devices or computing devices. Additionally or alternatively, the connected device 400 can relay signals through the computing device 490. In such examples, the computing device 490 can run the gesture application and the link 425 can be established automatically, or configured by a user.

The connected device 400 can include a pairing port 435, which allows the connected device 400 to pair with other connected devices. The pairing port 435 may comprise one or more coils to communicate with the computing device 490 and/or other connected devices. Accordingly, the connected device 400 can inductively pair with such other devices to allow the system 100, as disclosed in FIG. 1, to form associations between the devices. Thus, connected devices may pair with each other through established links over a graphical user interface via the gesture application, or by simply inductive pairing where devices are tapped together to form the pairing. Such an inductive pairing may be indicated by a gesture response on one or more of the connected devices (e.g., haptic response and/or lighting up).

Once paired with one or more other connected devices, the connect device 400 can receive inputs from a user that can be detected by one or more sensors 480 on the connected device 400. The sensors 480 can include any number of any type or combination of sensor. For example, the sensors 480 can include a number of accelerometers, touch sensors, pressure sensors, thermal sensors, analog buttons, and the like. Such sensors 480 can be arranged on and within the connected device 400 to detect any number of user interactions, such as squeezing, throwing, tapping, rotating, dropping, shaking, twisting, or breaking a whole or a portion of the connected device 400. Such user interactions may be communicated to other connected devices over long distances (e.g., anywhere in the world).

Communication of user interactions can take place via a transceiver 420 in the connected device 400. The transceiver 420 can be any suitable wireless transceiver to establish the link 425 with the computing device 490 or a network. For example, the transceiver 420 can be a Bluetooth or other RF transceiver module. Raw sensor data corresponding to user interactions with the connected device 400 can be directly communicated to the computing device 490 for external processing. Alternatively, the sensor data can be processed internally on the connected device 400 to provide information related to the type of user interaction.

In variations, a memory 440 can be included to store lookup information related to types of user interactions in correlation with sensor inputs. In such variations, the input from the sensors 480 can be processed by a controller 430, which can determine, based on the sensor inputs, the type of user interaction performed on the connected device 400. Accordingly, the controller 430 can communicate information relating to the type of user interaction to the computing device 490 via the transceiver 420.

The memory 440 can further store instructions executable by the controller 430. Such instructions can cause the controller 430 to perform various operations based on sensor inputs from the sensors 480, and/or communications transmitted from the computing device 490 or over a network. For example, a user interaction with the connected device 400 can cause the controller 430 to operate any number of internal electronic components included with the connected device 400. Such electronics can include, for example, a light system 460 including one or more lights on the connected device 400, an audio system 440 including one or more auditory devices (e.g., a speaker), a haptic system 470 to cause a whole or one or more portions of the connected device to vibrate, or a mechanical system 450 to cause the connected device 400 to perform physical gestures.

Thus, the controller 430 can ultimately control the connected device 400 to perform any number of gestures incorporating any of the foregoing systems. For example, a user performing a squeeze input on the connected device 400 can cause the connected device 400 to light up and vibrate. Furthermore, an input (e.g., squeeze input) on an associated connected device located any distance from the connected device 400 can cause the connected device 400 to perform a gesture. As such, a user interaction with a distant associated connect device can be communicated, via the computing device 490, to the connected device 400, which can perform an associated gesture (e.g., light up and raise its arms).

Furthermore, gestures may be banked either in the memory 440 of the connected device 400, or within the system 100 as described with respect to FIG. 1. Banked gestures can correspond to received data that a user interaction has been performed on an associated connected device. For example, the connected device 400 may be in a deep sleep mode, or dormant mode, when such a user interaction on a distant connected device takes place. Accordingly, a gesture may be saved for the connected device 400 to be performed when the connected device awakes.

Awakening the connected device 400 can be achieved by any suitable means. For example, the connected device 400 can be awakened by a user touching or moving the connected device 400 itself. Additionally or alternatively, the connected device 400 can be awakened when the computing device 490 establishes the link 425 or otherwise enters within a predetermined proximity from the connected device 400. Further still, the device can be awakened to perform a banked gesture by a user pushing a specific button or performing a specific action on the connected device 400.

In variations, any of the electronics in the connected device 400 can be removable and can be inserted into another connected device. For example, the controller 430 and/or memory 440 can behave as the “brain” of the connected device 400, and can be removable and inserted into another device. Thus, stored data included in the memory 440 can be transferred between devices. In such variations, a radio frequency identification (RFID) chip 410 can be included in the connected device 400. Accordingly, upon insertion of the brain (i.e., memory 440 and/or controller 430), the system 100 can determine that the user is associated with the connected device 400. Furthermore, new or different gestures and/or behaviors stored on the memory 440 can be performed as the brain is transferred from device to device.

The connected device 400 can further include a location-based system. Accordingly, the connected device 400 can be programmed or otherwise caused to perform any number of gestures upon entering a predetermined proximity from any number of locations. Alternatively, the connected device 400 can utilize a location based function on the computing device 490 to be location aware. As an example, the connected device 400 can determine that it is within a certain distance (e.g., 1 mile) from, for example, a home location or a theme park, causing the connected device 400 to perform a preselected gesture.

Hardware Diagram

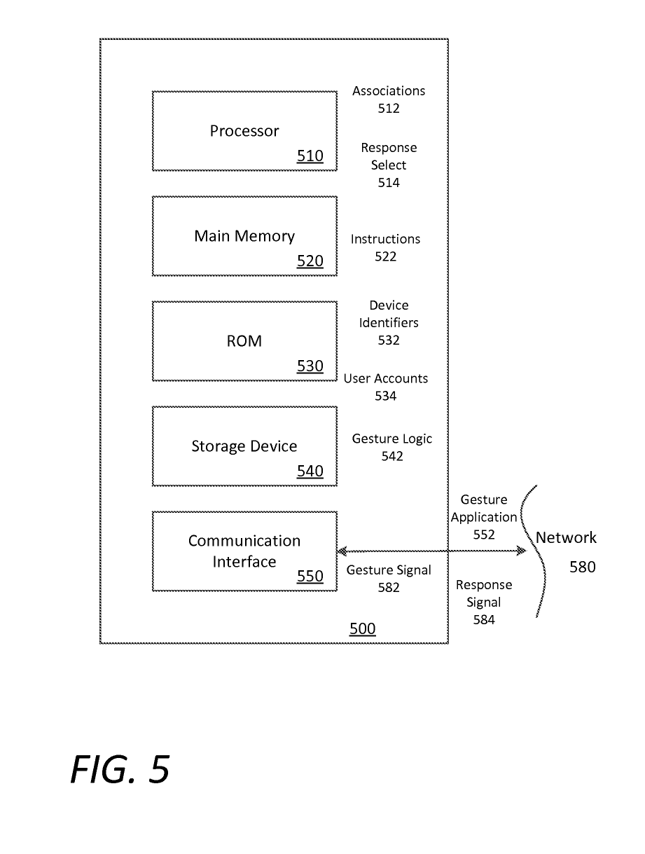

FIG. 5 is a block diagram that illustrates a computer system upon which examples described may be implemented. For example, one or more components discussed with respect to the system 100 of FIG. 1 and the method of FIGS. 2-3 may be performed by the system 500 of FIG. 5. The system 100 can also be implemented using a combination of multiple computer systems as described by FIG. 5.

In one implementation, the computer system 500 includes processing resources 510, a main memory 520, ROM 530, a storage device 540, and a communication interface 550. The computer system 500 includes at least one processor 510 for processing information and a main memory 520, such as a random access memory (RAM) or other dynamic storage device, for storing information and instructions 522 to be executed by the processor 510. The main memory 520 also may be used for storing temporary variables or other intermediate information during execution of instructions to be executed by the processor 510. The computer system 500 may also include a read only memory (ROM) 530 or other static storage device for storing static information and instructions for the processor 510. A storage device 540, such as a magnetic disk or optical disk, is provided for storing information and instructions. For example, the storage device 540 can correspond to a computer-readable medium that trigger gesture logic 542 for performing operations discussed with respect to FIGS. 1-4.

The communication interface 550 can enable computer system 500 to communicate with one or more networks 580 (e.g., cellular or Wi-Fi network) through use of the network link (wireless or wireline). Using the network link, the computer system 500 can communicate with a plurality of devices, such as the mobile computing devices of the clients and service providers. The computer system 500 can further supply the gesture application 552 via the network link to any of the clients. According to some examples, the computer system 500 can receive gesture signals 582 from the mobile computing devices of the clients and service providers via the network link. The communication interface 550 can further be utilized to transmit response signals 584 to various mobile computing devices in response to the gesture signals 582. Furthermore, the ROM 530 (or other storage device) can store device identifiers 532 and user accounts 534, which include various user information concerning previous device connections and device associations. The processor 510 can access the user accounts 534 to look up device identifiers 532 to determine the particular associations 512 between connected devices and computing devices. Once the processor 510 determines the associations 512, the processor 510 can make response selections 514 and generate response signals 584 to be transmitted to those associated devices.

Examples described herein are related to the use of computer system 500 for implementing the techniques described herein. According to one example, those techniques are performed by computer system 500 in response to processor 510 executing one or more sequences of one or more instructions contained in main memory 520, such as the gesture logic 542. Such instructions may be read into main memory 520 from another machine-readable medium, such as storage device 540. Execution of the sequences of instructions contained in main memory 520 causes processor 510 to perform the process steps described herein. In alternative implementations, hard-wired circuitry may be used in place of or in combination with software instructions to implement examples described herein. Thus, the examples described are not limited to any specific combination of hardware circuitry and software.

### CONCLUSION

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that this disclosure is not limited to those precise examples. As such, many modifications and variations will be apparent to practitioners skilled in this art. Accordingly, it is intended that the scope of this disclosure be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude the inventor from claiming rights to such combinations.

Although illustrative examples have been described in detail herein with reference to the accompanying drawings, variations to specific examples and details are encompassed by this disclosure. It is intended that the scope of the invention is defined by the following claims and their equivalents. Furthermore, it is contemplated that a particular feature described, either individually or as part of an example, can be combined with other individually described features, or parts of other examples. Thus, absence of describing combinations should not preclude the inventor(s) from claiming rights to such combinations.

While certain examples have been described above, it will be understood that the examples described are by way of example only. Accordingly, this disclosure should not be limited based on the described examples. Rather, the scope of the disclosure should only be limited in light of the claims that follow when taken in conjunction with the above description and accompanying drawings.

What is claimed is:

1. A system comprising:
a database storing unique identifiers matching connected devices with related connected devices;
one or more processors; and
one or more memory resources storing instructions that, when executed by the one or more processors, cause the one or more processors to:
receive a gesture signal indicating a user interaction with a first connected device;
perform a lookup in the database to identify one or more related connected devices associated with the first connected device; and
transmit a response signal to cause the one or more related connected devices to perform an associated gesture signifying the user interaction with the first connected device.

2. The system of claim 1, wherein the gesture signal is relayed from the first connected device through a first mobile computing device associated with the first connected device.

3. The system of claim 2, wherein the response signal is transmitted through one or more related mobile computing devices associated with the one or more related connected devices to cause the one or more related connected devices to perform the associated gesture.

4. The system of claim 3, wherein the instructions, when executed by the one or more processors, further cause the one or more processors to:
receive a pairing signal indicating that the first connected device has paired with the one or more related connected devices; and
access the database to associate unique identifiers corresponding to the first connected device and the one or more related connected devices.

5. The system of claim 3, wherein the first connected device and the one or more related connected devices are semi-autonomous toys capable of animating a plurality of preconfigured gestures, and wherein the user interaction is one of a plurality of predetermined interactions with the first connected device specific to trigger the response signal.

6. The system of claim 5, wherein the instructions, when executed by the one or more processors, further cause the one or more processors to:
in response to receiving a gesture signal, selecting the associated gesture, from a plurality of associated gestures stored in the database; and
based on the selected associated gesture, generate the response signal to be transmitted to cause the one or more related connected devices to perform the associated gesture.

7. The system of claim 6, wherein the plurality of preconfigured gestures includes one or more haptic, visual, audible, or physical gestures to be performed by the one or more related connected devices, and wherein generating the response signal includes incorporating a specific combination of the one or more haptic, visual, audible, or physical gestures to represent the associated gesture.

8. The system of claim 3, wherein the gesture signal further indicates that only a specified connected device, of the one or more related connected devices, is to receive the response signal, and wherein the response signal is transmitted to only cause the specified connected device to perform the associated gesture.

9. The system of claim 3, wherein the instructions, when executed by the one or more processors, further cause the one or more processors to:
prior to receiving the gesture signal, receive a launch signal indicating that the first mobile computing device has launched an application specific to the system; and
prior to transmitting the response signal, determining whether the one or more related mobile computing devices are currently running the application.

10. The system of claim 9, wherein the instructions, when executed by the one or more processors, further cause the one or more processor to:
in response to determining that the one or more related mobile computing devices are not currently running the application, associate the response signal with the one or more related mobile computing devices; and
queue transmission of the response signal until one or more subsequent launch signals are received indicating that the one or more related mobile computing devices have launched the application.

11. The system of claim 4, wherein the instructions, when executed by the one or more processors, further cause the one or more processors to:
in response to receiving the pairing signal, initiate a timer associated with the first connected device being paired to the one or more related connected devices; and
after a predetermined duration, unpair the first connected device from the one or more related connected devices.

12. The system of claim 11, wherein unpairing the first connected device from the one or more related connected devices includes disassociating the unique identifiers corresponding to the first connected device and the one or more related connected devices.

13. The system of claim 4, wherein the instructions, when executed by the one or more processors, further cause the one or more processors to:
receive an unpairing signal indicating that the first connected device has unpaired with the one or more related connected devices; and
access the database to disassociate the unique identifiers corresponding to the first connected device and the one or more related connected devices.

14. The system of claim 3, wherein the instructions, when executed by the one or more processors, further cause the one or more processors to:
receive a simultaneous gesture signal indicating a second user interaction with one of the one or more related connected devices; and
transmit a second response signal to the first mobile computing device to cause the first connected device to perform a second associated gesture.

15. The system of claim 14, wherein the instructions, when executed by the one or more processors, further cause the one or more processors to:
based on receiving the simultaneous gesture signal, generate the response signal and the second response signal to intensify the associated gesture and the second associated gesture.

16. The system of claim 3, wherein the instructions, when executed by the one or more processors, further cause the one or more processors to:
detect, via location-based resources on the first mobile computing device and the one or more related mobile computing devices, that the first connected device is within a predetermined distance from the one or more related connected devices; and
transmit respective response signals to the first mobile computing device and the one or more related mobile computing devices to cause the first connected device and the one or more related connected devices to each perform a predetermined gesture.

17. The system of claim 3, wherein the first mobile computing device and the one or more related mobile computing devices are connected to their respective first connected device and the one or more related connected devices via respective Bluetooth links, and wherein the first mobile computing device and the one or more related mobile computing devices are connected to the system via a network.

18. The system of claim 1, wherein the instructions, when executed by the one or more processors, further cause the one or more processors to:
process the gesture signal to determine the user interaction, the user interaction being one or more of squeezing, throwing, tapping, rotating, dropping, shaking, twisting, or breaking a whole or a portion of the first connected device.

19. A computer-implemented method performed by one or more processors and comprising:
receiving a gesture signal indicating a user interaction with a first connected device;
performing a lookup, in a database storing unique identifiers matching connected devices with related connected devices, to identify one or more related connected devices associated with the first connected device; and
transmitting a response signal to cause the one or more related connected devices to perform an associated gesture signifying the user interaction with the first connected device.

20. A non-transitory computer-readable medium storing instructions that, when executed by one or more processors, cause the one or more processors to:
receive a gesture signal indicating a user interaction with a first connected device;
perform a lookup, in a database storing unique identifiers matching connected devices with related connected devices, to identify one or more related connected devices associated with the first connected device; and
transmit a response signal to cause the one or more related connected devices to perform an associated gesture signifying the user interaction with the first connected device.
